(19) United States
(12) Patent Application Publication
(10) Pub. No.: US 2014/0048388 A1
(43) Pub. Date: Feb. 20, 2014

(54) CONVEYOR SYSTEM, CONVEYOR APPARATUS AND TROUGHED PULLEY

(71) Applicant: Kenneth Monroe Hefner, St. John, IN (US)

(72) Inventor: Kenneth Monroe Hefner, St. John, IN (US)

(21) Appl. No.: 13/585,354

(22) Filed: Aug. 14, 2012

(51) Int. Cl. B65G 15/24; B65G 15/60

(52) U.S. Cl. CPC B65G 15/24; B65G 15/60
USPC 198/606; 198/824

(57) ABSTRACT

In one example embodiment, a conveyor apparatus includes a belt, a drive pulley, a troughed pulley, and a motor configured to operate with the belt, the drive pulley and the troughed pulley to drive the belt.

### BACKGROUND

Conveyor systems can be relatively large systems (e.g., conveyor systems found in coal fire electric generating plants) or relatively small systems (e.g., conveyor systems found in commercial retail centers). Conveyor systems typically include a pulley that rotates with respect to a frame and that drives a belt surrounding the pulley. Conveyor systems also typically include a motor that drives a gear reducer, which, in turn, drives one or more pulleys that, in turn, drives movement of the belt coupled to the pulleys.

The belts used are often robust, but are susceptible to damage from a variety of sources. While the discharge of goods from a conveyor belt usually does not cause damage to the belt, the act of depositing goods and materials onto a conveyor belt has the potential to cause damage. In this regard, when a belt is being used to transport coal, aggregate and other coarse and heavy material, the deposit of these types of rocks onto the belt can generate tremendous impact forces on the belt. These impact forces and random flow of material may cause off center loading of the material on the surface of the belt of the receiving conveyor. Off center loading may cause the belt of the receiving conveyor to draw. A drawn belt often results in spillage of the material from the sides of the receiving conveyor which increases maintenance costs and presents a safety and health hazard due to dust generation which could be inhaled by persons or could create a fire or explosion hazard. Further, the edge of a drawn belt can drag against a skirt of a conveyor system causing wear to the belt and skirt, which can increase power requirements of the conveyor system. The skirt drag can also require that the skirt and conveyor be repaired or components replaced more frequently.

Accordingly, a need exists for the further development of conveyor systems.

### SUMMARY

In one example embodiment, a conveyor apparatus includes: (a) a belt; (b) a drive pulley; and (c) a troughed pulley; and (d) a motor configured to operate with the belt, the drive pulley and the troughed pulley to drive the belt; and a second conveyor apparatus configured to transfer materials to the first conveyor apparatus.

In one example embodiment, a troughed pulley includes a drum having: (a) a first end having a first circumference; (b) a second end having a second circumference; (c) a middle portion having a third circumference; (d) a first slope formed between the first end and the middle portion; and (e) a second slope formed between the second end and the middle portion, the first circumference being larger than the third circumference, the second circumference being larger than the third circumference.

Additional features and advantages are described herein, and will be apparent from the following Detailed Description and figures.

### BRIEF DESCRIPTION OF THE FIGURES

FIG. 1 is a side plan view of one example embodiment of the conveyor system disclosed herein.

FIGS. 2A and 2B are perspectives views of alternative example embodiments of drive systems.

FIG. 3 is a cut-away perspective view of an example conveyor apparatus, illustrating a troughed pulley providing a transition to a troughing roller assembly.

FIG. 4 is a cut-away perspective view of an example troughed pulley, illustrating support rings having different sizes.

FIG. 5 is a cross sectional view of an example troughed pulley, taken substantially along line 5 of FIG. 4, illustrating a support ring and a circumference of the support ring and drum.

FIG. 6 is a cross sectional view of an example troughed pulley, taken substantially along line 6 of FIG. 4, illustrating a support ring and a circumference of the support ring and drum.

FIG. 7 is a cross sectional view of an example troughed pulley, taken substantially along line 7 of FIG. 4, illustrating a support ring and a circumference of the support ring and drum.

FIG. 8 is an exploded perspective view of an example troughed pulley, illustrating an example retrofit.

FIG. 9 is schematic view of an example troughed pulley, illustrating example lengths of certain section of the troughed pulley.

### DETAILED DESCRIPTION

The present disclosure relates in general to a conveyor system for providing notifications based on occurrences of lead triggering events for real estate property assigned to a real estate groups. Briefly, in an example embodiment, a search area module receives selections to create a search area for a map. A real estate property generation module generates real estate property data based the created search area. Thereafter, in response to a realtor request, a real estate property assignment module assigns the real estate property data to a real estate property group. In response to a determination that a lead triggering event occurs for real estate property assigned to a real estate group, the notification generate a notification indicative of the occurrence of the lead triggering event.

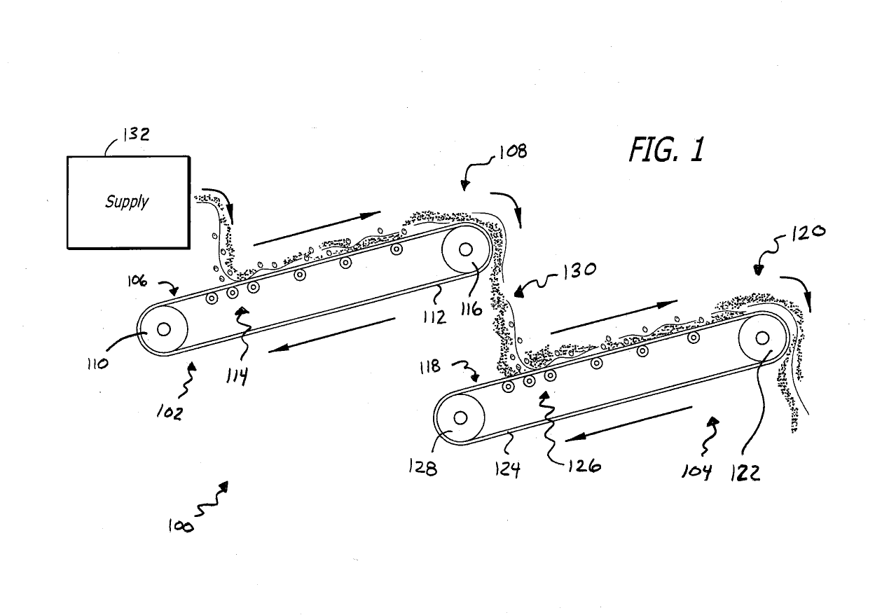

Referring to FIG. 1, in this example embodiment, conveyor system 100 includes: (a) supply 132; (b) first conveyor apparatus 102; and (c) second conveyor apparatus 104.

In some example embodiments, bulk material 106 may be supplied to the conveyor system by

As illustrated in FIG. 1, first conveyor apparatus 102 has first receiving end 106 and first discharge end 108.

As illustrated in FIG. 1, second conveyor apparatus 104 has second receiving end 118 and second discharge end 120.

In this example embodiment, first conveyor apparatus 102 includes: (a) first troughed pulley 110; (b) first belt 112; (c) first troughing assembly 114; (d) first drive pulley 116; and (e) a drive system (not shown).

In this example embodiment, second conveyor apparatus 104 includes: (a) second troughed pulley 122; (b) second belt 124; (c) second troughing assembly 126; (d) second drive pulley 128; and (e) a drive system (not shown).

In operation, as illustrated in FIG. 1, first conveyor apparatus 102 transfers bulk material 130 to second conveyor apparatus 104. In this example embodiment, bulk material 103 is supplied by supply 132. As shown in FIG. 1, first conveyor apparatus 102 discharges bulk material 103 from first discharge end 108. Bulk material 103 is transferred onto second receiving end 118 of second conveyor apparatus 104.

It should be appreciated that conveyor system 100 may include additional conveyor apparatuses which may or may not include a troughed pulley described herein, however, for convenience of discussion purposes, conveyor system 100 has been illustrated as including only first conveyor apparatus 102 and second conveyor apparatus 104.

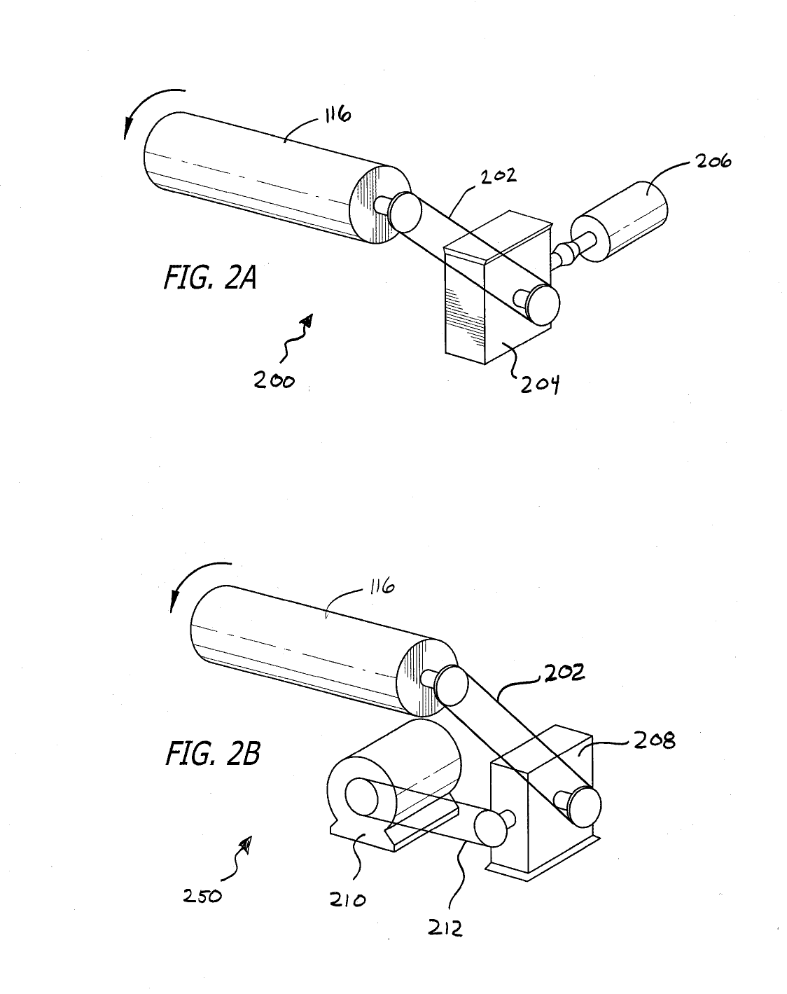

In some example embodiments, a conveyor apparatus includes a drive system. For example, conveyor apparatus 102 may include drive system 200 shown in FIG. 2A. As illustrated in FIG. 2A, drive system 200 may include: (a) drive pulley 116; (b) belt 202; (c) gear reducer or speed reducer 204; and (d) motor 206. In operation, motor 206 is configured to drive gear reducer 204, which, in turn, drives drive pulley 116 that, in turn, drives movement of first belt 112. In one example embodiment, second conveyor apparatus 104 employs the same type of drive system as first conveyor apparatus 102 (i.e., drive system 200). In another example embodiment, second conveyor apparatus 104 employs a different type of drive system than the drive system employed by first conveyor apparatus 102.

In some example embodiments, the drive system includes a belt operatively connected to a motor and a speed reducer or gear reducer. For example, referring to FIG. 2B, example drive system 250 includes belt 212 which is operatively coupled to motor 210 and speed reducer 208. In operation, motor 210 is configured to, using belt 212, drive gear reducer 208, which, in turn, drives pulley 116 that, in turn, drives movement of first belt 112.

In some embodiments, belt 202 and belt 212 include a chain. In some embodiments, belt 202 and belt 204 include a v-belt.

It should be appreciated that first conveyor apparatus 102 and second conveyor apparatus 104 may employ any suitable driving system.

In some embodiments, first belt 110 includes a conveyor belt.

Bulk material 106 may include any suitable material including coal.

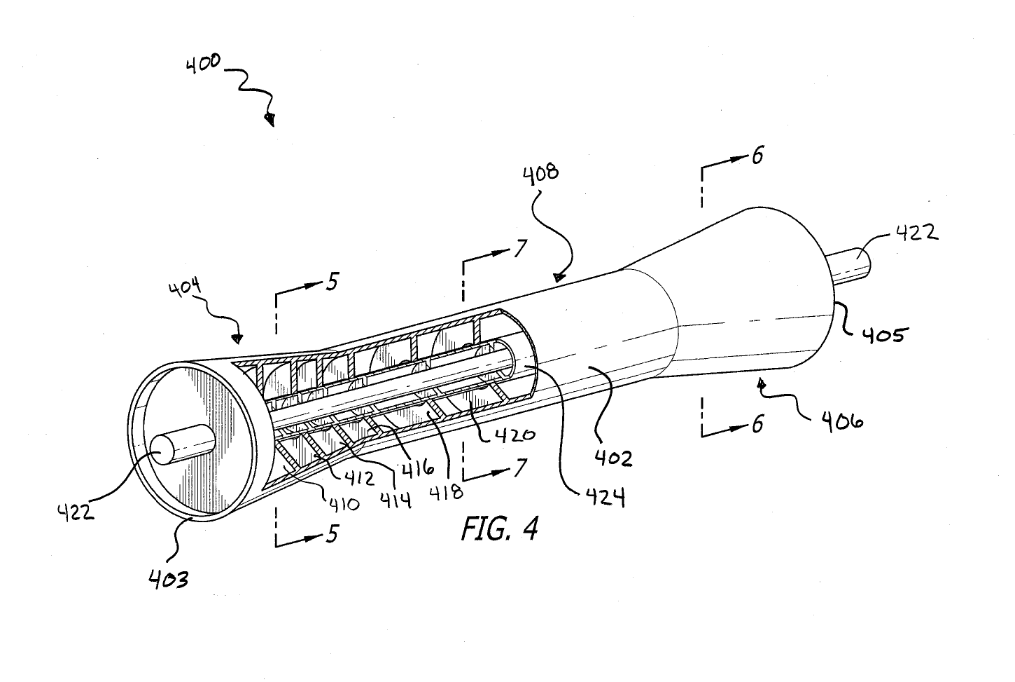

In some example embodiments, the troughed pulley includes a drum. For example, referring to FIG. 4, in this example, troughed pulley 400 includes drum 402.

In some example embodiments, the drum of the troughed pulley includes a plurality of portions. For example, as illustrated in FIG. 4, troughed pulley 400 includes first end portion 404; (b) second end portion 406; and (c) middle portion 408. In this example, it should be appreciated that first end portion and second end portion are sloped and the middle portion has a cylindrically shaped cross-section which remains constant

In FIG. 4, drum 402 has first end 403 and second end 405.

In some example embodiments, the troughed pulley includes drum support rings. For example, as best illustrated in FIG. 4, troughed pulley 400 includes first support ring 410, second support ring 412, third support ring 414, fourth support ring 416, fifth support ring 418, sixth support ring 420. In this example, as best shown in FIG. 4, the drum support rings are disposed such that the outer circumferences of the drum support rings contact the inner face of the drum. Such a configuration enables drum 402 to be concentrically disposed relative to cylinder 424.

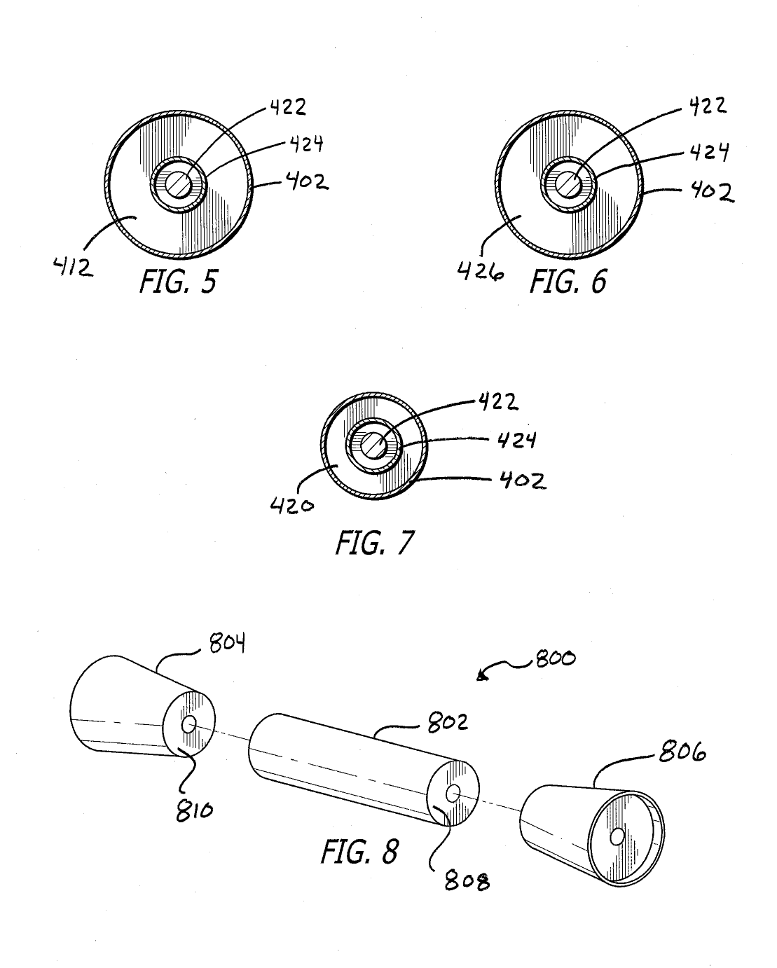

As best illustrated in FIGS. 4, 5, 6 and 7, in some example embodiments, some of the support rings have different sizes. FIG. 5 is a cross sectional view of troughed pulley 400, taken substantially along line 5 of FIG. 4, illustrating a portion of drum 402 having a first circumference and drum support ring 412 having a first outer circumference. FIG. 6 is a cross sectional view of troughed pulley 400, taken substantially along line 6 of FIG. 4, illustrating a portion of drum 402 having a second circumference and drum support ring 426 having an second outer circumference. It should be appreciated that, in this example, the size of the first circumference of drum 402 shown in FIG. 5 is the same size as the second circumference of drum 402 shown in FIG. 6. FIG. 7 is a cross sectional view of troughed pulley 400, taken substantially along line 7 of FIG. 4, illustrating a portion of drum 402 having a third circumference and drum support ring 420 having a third outer circumference. It should be appreciated that, in this example, the size of the third circumference of drum 402 shown in FIG. 7 is smaller than the first circumference and the second circumference of drum 402 shown in FIGS. 5 and 6.

In some embodiments, the troughed pulley includes a taper lock. In some embodiments, the taper lock is configured to attach the troughed pulley to a shaft. For example, referring to FIG. 4, troughed pulley 400 may be attached to shaft 422 using a taper lock.

The troughed pulleys described herein may be made from steel and constructed of steel and traditional pulley materials according to industry standards.

In some embodiments, the troughed pulley described herein may be referred to as a tail pulley.

In some example embodiments, the conveyor system includes a large hopper or transfer chute. The large hopper or transfer chute may receive bulk material from a discharge end of a conveyor apparatus and control or facilitate the flow of the material onto the receiving end of a conveyor apparatus.

In one example embodiment, the troughed pulley is constructed by retrofitting an already existing tail pulley. For example, as illustrated FIG. 8, troughed pulley 800 is constructed by retrofitting tail pulley 802.

In this example, troughed pulley 800 includes tail pulley 802, first flange cap 804 and second flange cap 806.

In this example, tail pulley 802 has first face 808 and second, opposite. First flange cap 804 has third face 810 and second flange cap has fourth face (not shown).

The flange caps may be connected to the tail pulley in any suitable way to form the troughed pulley. In one example embodiment, troughed pulley 800 is formed by: (a) welding third face 810 to the second face of tail pulley 802; and (b) welding first face 808 to the fourth face of second flange cap 806.

It should be appreciated that difference sized flange caps may used to create a desired trough slope.

In one embodiment, the trough tail pulley is built to meet existing conveyors systems and subject to existing system specifications.

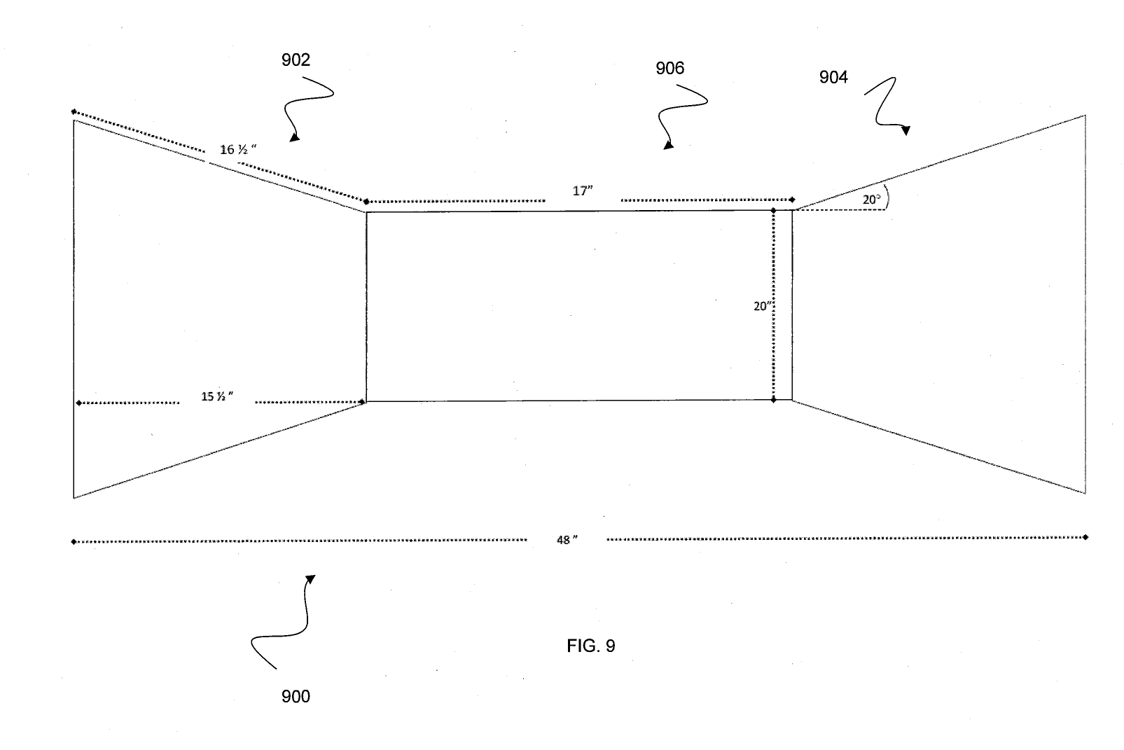

Referring to FIG. 9, in this example embodiment, schematic view of example troughed pulley 900, illustrating example lengths of certain section of the troughed pulley.

In this example embodiment, troughed pulley 900 includes: (a) first end portion 902; (b) second end portion 904; and (c) middle portion 906.

In this example embodiment, first end portion 902 and second end portion 904 are symmetrical. As illustrated in this example, the sloped portion of the first end portion 902 has a length of 16.5 inches and has a run of 15.5 inches. As shown in FIG. 9, in this example, the sloped angle is twenty degrees.

In this example, the overall length of troughed pulley 900 is forty-eight inches.

In this example, the length of the middle section is seventeen inches and the diameter of the middle section is twenty inches.

It should be appreciated that the dimensions of troughed pulley 900 shown in FIG. 9, are merely examples and are not intended to be strictly limited to the specific lengths and angle discussed above.

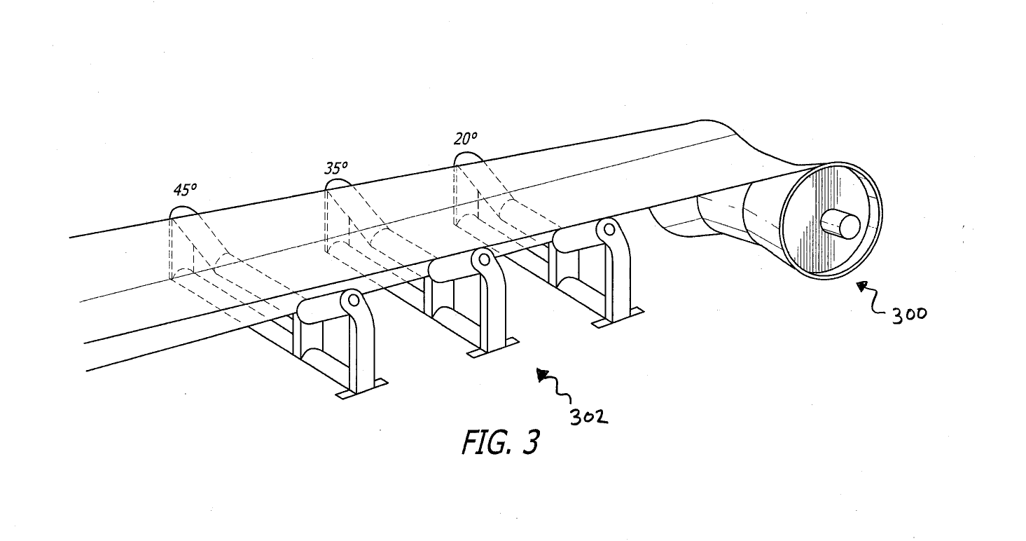

As illustrated in FIG. 3, in some example embodiments, troughed pulley 300 may provide a smooth transition to troughing roller assembly 302.

It should be appreciated that the troughed pulley described herein may create a natural transition to a conveyor system's troughing roller assembly. It should be appreciated that this natural transition may reduce spillage bulk material, avoids excess dust generation from the transfer of the material, reduces material degradation, reduce stress and wear of the receiving conveyor components thereby reducing maintenance and repair costs, and reduce power requirements of the receiving conveyor.

It should also be appreciated that the troughed pulley described herein may eliminate or reduce negative effects of material off center loading. These negative effects may include belt misalignment. When off center loading occurs in belt transition load zones (e.g., receiving end 118), the troughed pulley's slope may serve as a resistance to common belt slide/draw. Utilizing the troughed tail pulley in a conveyor system at the existing system's troughed degree before the material load zone, the conveyor belt may remain in a centered position.

For the conveyor belt, the troughed tail pulley may effectively eliminates a transition for the conveyor belt to reach the degree of the conveyor belt when the conveyor belt is positioned over the troughing roller system because the conveyor belt is already in the system's troughed degree upon engaging the pulley itself

It should be further appreciated that by employing the troughed pulley described herein the conveyor belt may be more likely to remain centered with resistance to slip or drawing off the system.

In some example embodiments, the troughed pulley may effectively eliminate the belt transition zone.

It should be appreciated that, in some example embodiments, the troughed pulley may improves overall troughing and belt-to-roller contact. Further, the use of the troughed pulley may help prevent material spillage, belt wear, excessive heat and uneven trough roller wear.

In some example embodiments, the use of the troughed pulley may effectively eliminate a need for return training rollers and may help prevent Idler Junction Failure which is the phenomenon that causes conveyor belt ply layers to ultimately snap from excessive bending of the belt while traveling through the transitional troughing angles. Because the belt will remain at the troughed angle through the entire tail area and load zone of the system, no excessive bending will occur.

In different examples, the troughed tail pulley of a bulk belt conveyor may be beneficially used in coal fired electric generating plants, stone, metallic mining, clay, glass, cement, coal mining and preparation plants, transportation terminals, solid waste, concrete and wood recycling plants, and steel mills.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A conveyor system comprising:
a first conveyor apparatus including:
(a) a belt;
(b) a drive pulley; and
(c) a troughed pulley; and
(d) a motor configured to operate with the belt, the drive pulley and the troughed pulley to drive the belt; and
a second conveyor apparatus configured to transfer materials to the first conveyor apparatus.

2. The conveyor system of claim 1, wherein the troughed pulley includes a drum, the drum having:
(a) a first end having a first circumference;
(b) a second end having a second circumference; and
(c) a middle portion having a third circumference, the first circumference being larger than the third circumference, the second circumference being larger than the third circumference.

3. The conveyor system of claim 2, wherein troughed pulley has:
(a) a first sloped portion between the first end and the middle portion; and
(b) a second sloped portion between the second end and the middle portion.

4. The conveyor system of claim 2, wherein the first circumference is the same size as the third circumference.

5. The conveyor system of claim 2, wherein the troughed pulley includes a drum having:
(a) a first end portion;
(b) a second end portion; and
(c) a middle portion.

6. The conveyor system of claim 5, wherein the troughed pulley includes:
(a) a first support ring disposed within the first end portion;
(b) a second support ring disposed within the second end portion; and
(c) a third support ring disposed within the middle portion.

7. The conveyor system of claim 6, wherein the third support ring has a smaller diameter than the first support ring and the second support ring.

8. The conveyor system of claim 1, wherein second conveyor apparatus includes:
(a) a second belt;
(b) a second drive pulley; and
(c) a tail pulley; and
(d) a second motor configured to operate with the second belt, the second drive pulley and the tail pulley to drive the second belt.

9. The conveyor system of claim 8, wherein tail pulley is a second troughed pulley.

10. The conveyor system of claim 1, wherein the belt includes an endless belt.

11. A conveyor apparatus configured to receive materials, the conveyor apparatus comprising:
a motor;
a drive pulley operatively coupled to the motor; and
a troughed pulley.

12. The conveyor apparatus of claim 11, wherein the troughed pulley includes a drum, the drum having:
(a) a first end having a first circumference;
(b) a second end having a second circumference; and
(c) a middle portion having a third circumference, the first circumference being larger than the third circumference, the second circumference being larger than the third circumference.

13. The conveyor apparatus of claim 12, wherein troughed pulley has:
(a) a first sloped portion between the first end and the middle portion; and
(b) a second sloped portion between the second end and the middle portion.

14. The conveyor apparatus of claim 13, wherein the first circumference is the same size as the third circumference.

15. A pulley comprising:
a drum having:
(a) a first end having a first circumference;
(b) a second end having a second circumference;
(c) a middle portion having a third circumference;
(d) a first slope formed between the first end and the middle portion; and
(e) a second slope formed between the second end and the middle portion, the first circumference being larger than the third circumference, the second circumference being larger than the third circumference.

16. The pulley of claim 15, wherein the troughed pulley includes a drum, the drum having:
(a) a first end having a first circumference;
(b) a second end having a second circumference; and
(c) a middle portion having a third circumference, the first circumference being larger than the third circumference, the second circumference being larger than the third circumference.

17. The pulley of claim 16, wherein troughed pulley has:
(a) a first sloped portion between the first end and the middle portion; and
(b) a second sloped portion between the second end and the middle portion.

18. The pulley of claim 16, wherein the first circumference is the same size as the third circumference.

19. The pulley of claim 16, wherein the troughed pulley includes a drum having:
(a) a first end portion;
(b) a second end portion; and
(c) a middle portion.

20. The pulley of claim 19, wherein the troughed pulley includes:
(a) a first support ring disposed within the first end portion;
(b) a second support ring disposed within the second end portion; and
(c) a third support ring disposed within the middle portion.
